(19) United States
(12) Patent Application Publication
(10) Pub. No.: US 2008/0260193 A1
(43) Pub. Date: Oct. 23, 2008

(54) INTERCHANGEABLE ACOUSTIC SYSTEM FOR A HEARING AID, AND A HEARING AID

(75) Inventors: Soren Erik WESTERMANN, Humlebak (DK); Henrik Heile Christensen, Brondby (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/104,220

(22) Filed: Apr. 16, 2008

Related U.S. Application Data
(63) Continuation-in-part of application No. PCT/DK2006/050059, filed on Oct. 12, 2006.

(30) Foreign Application Priority Data
Oct. 17, 2005 (DK) PA200501454

(51) Int. Cl. H04R 25/02; H04R 25/00

(52) U.S. Cl. 381/330; 381/312

(57) ABSTRACT

An acoustic system (3) for a hearing aid is adapted for conducting sound from an output transducer in the hearing aid housing to an ear of a user. The acoustic system (3) comprises an encoding (8, 9) indicating acoustical properties of the acoustic system (3). Hereby the electronics of the hearing aid can identify the type of acoustic system attached to the hearing aid housing. The invention further provides a hearing aid with an acoustic system.

### RELATED APPLICATIONS

The present application is a continuation-in-part of application No. PCT/DK/2006/050059; filed on Oct. 12, 2006, in Denmark and published as WO2007045254, the contents of which are incorporated hereinto by reference.

The present invention is based on, and claims priority from PA200501454, filed on Oct. 17, 2005, In Denmark, the contents of which are incorporated hereinto by reference.

### BACKGROUND OF THE INVENTION

1. Field of the Invention

The present invention generally relates to hearing aids. The invention, more specifically, relates to an acoustic system for a hearing aid, where said acoustic system is adapted for conducting sound from an output transducer in a housing of said hearing aid to an ear of a user. The invention moreover relates to a hearing aid, in particular a BTE hearing aid, comprising a hearing aid housing, where said housing has means for attaching an acoustic system for conducting sound from an output transducer in the hearing aid housing to an ear of a user.

2. Prior Art

In hearing aids worn Behind The Ear, i.e. BTE hearing aids, it is commonly known to use an acoustic system for conducting the sound produced by the output transducer in the hearing aid housing to the ear. The acoustic system normally comprises a length of sound tube, which is at one end connected to an earplug. The other end of the sound tube is typically provided with a specialized adapter for attaching it to a connector part of the hearing aid housing. However, the tube itself may also constitute the adapter, provided of course that the connector part is devised accordingly.

Generally, there are two types of earplugs, viz. open and closed. Both types have advantages and drawbacks. For instance the closed earplug, which normally requires a tight fit into the ear canal, may under certain circumstances give rise to skin problems in the ear canal. Also, the closed earplug gives rise to the well known occlusion effect. A closed earplug on the other hand provides the possibility of achieving higher sound levels using the same energy consumption as compared to open earplugs.

In the fitting of the hearing aid due account must be taken of the acoustic system in order to get the proper degree of amplification. However, the acoustic properties of the two types are quite different. One important difference between the two types of acoustic systems is that the closed earplug adversely affects the phenomenon known as the ear canal resonance, i.e. the natural amplification of the un-occluded ear canal around approximately 3 kHz.

Because of the different properties of different acoustic systems the hearing aid is normally fitted to the user's hearing deficiency using just one of the two types. A change from one type to another as desired, e.g. to overcome the above skin problems, is not feasible as the setting of the electronics would no longer be appropriate.

It is the object of the present invention to overcome this and other problems.

### SUMMARY OF THE INVENTION

According to a first aspect of the invention this object is achieved by an interchangeable acoustic system for a hearing aid, where said acoustical system is adapted for conducting sound from an output transducer in the hearing aid housing of said hearing aid to an ear of a user, and where said interchangeable acoustic system comprises an encoding indicating acoustical properties of the interchangeable acoustic system.

By providing an encoding on the acoustic system it becomes possible for the electronics of the hearing aid to identify the type of the acoustic system attached to the hearing aid housing. The acoustic properties of the acoustic system can then be taken into account, and the signals to the output transducer modified accordingly, so as to produce an output sound adapted for the characteristics of the specific acoustic system attached to the hearing aid, in this way making it possible to make the acoustic systems interchangeable.

According to a second aspect of the invention this object is achieved by a hearing aid, in particular a BTE hearing aid, comprising a hearing aid housing, where said housing has a connector part for attaching an interchangeable acoustic system for conducting sound from an output transducer in the hearing aid housing to an ear of a user, and where said hearing aid comprises detecting means for detecting an encoding of an attached interchangeable acoustical system.

By providing a detection means it becomes possible for the hearing aid to identify the type of the acoustic system attached thereto, by means of its encoding. The acoustic properties of the acoustic system can then be taken into account, and the signals to the output transducer modified accordingly, so as to produce an output sound adapted for the characteristics of the specific acoustic system attached to the hearing aid.

According to a preferred embodiment of the acoustic system according to the invention, said system comprises an earplug and said encoding indicates whether the earplug is of the closed type or not. This is the simplest encoding possible, necessitating in principle only one bit of data. Generally this is sufficient because the user will normally use acoustic systems of the same dimensions, irrespective of the type. That is to say, the length and diameter of the sound tube would normally be the same for both types, and thus not influence the acoustic properties of the acoustic system to any noteworthy degree.

According to a further preferred embodiment, said acoustic system comprises a length of sound tube, and said encoding indicates the length of said sound tube. This allows the hearing aid to identify the acoustic system more precisely.

According to a more preferred embodiment, said acoustic system comprises an adapter for attaching the acoustic system to a hearing aid housing of a hearing aid, and said encoding comprises at least one electrically conductive area arranged in connection with the adapter. This allows the one bit encoding mentioned above. The encoding may then be decoded by the hearing aid by two respective contacts, between which contact is made or not, where contact identifies the open type earplug and no contact identifies the closed type or vice versa.

According to yet a further embodiment of the acoustic system according to the invention, said electrically conductive area arranged in connection with the adapter has a resistance value indicating the acoustical properties of the system. Different resistances detected between the contacts in the hearing aid, are then interpreted as different types of acoustic systems.

According to another embodiment of the acoustic system according to the invention, said encoding comprises a plurality of electrically conductive areas arranged in connection with the adapter. This allows an encoding of the acoustic system with several bits, thus allowing the identification of more different types of interchangeable acoustic systems.

According to a preferred embodiment of the hearing aid according to the invention, said detecting means comprises at least one pair of conductors arranged in connection with said connector part. This allows the hearing aid to detect the conductive encoding on an attached acoustic system.

According to another preferred embodiment, said detecting means comprises a plurality of pairs of conductors. This allows the hearing aid to detect the conductive encoding on an attached acoustic system as a several bit encoding.

According to a further preferred embodiment, the sound produced by said output transducer is modified in accordance with the encoding detected. This allows the hearing aid to provide the user with sound, which is largely not influenced by the type of attached acoustic system.

### BRIEF DESCRIPTION OF THE DRAWINGS

The invention will now be described in greater detail based on non-limiting examples of preferred embodiments and with reference to the appended drawings. On the drawings,

FIG. 1 illustrates a complete BTE hearing aid according to the invention comprising a hearing aid housing with an attached interchangeable acoustic system according to the invention,

FIG. 2 illustrates an interchangeable acoustic system according to the invention, and

FIG. 3 illustrates a hearing aid housing according to the invention adapted for the use with the interchangeable acoustic system of FIG. 2.

### DETAILED DESCRIPTION OF THE INVENTION

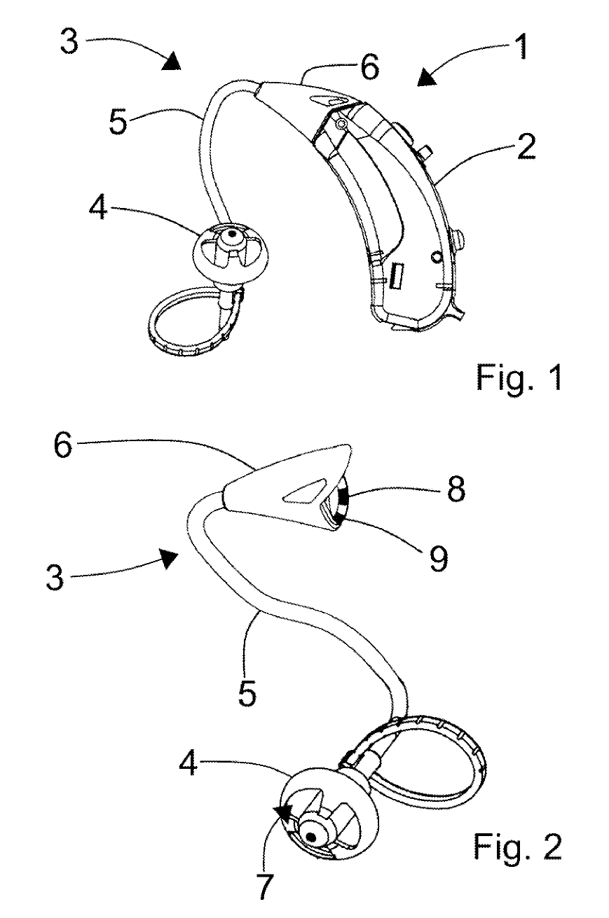

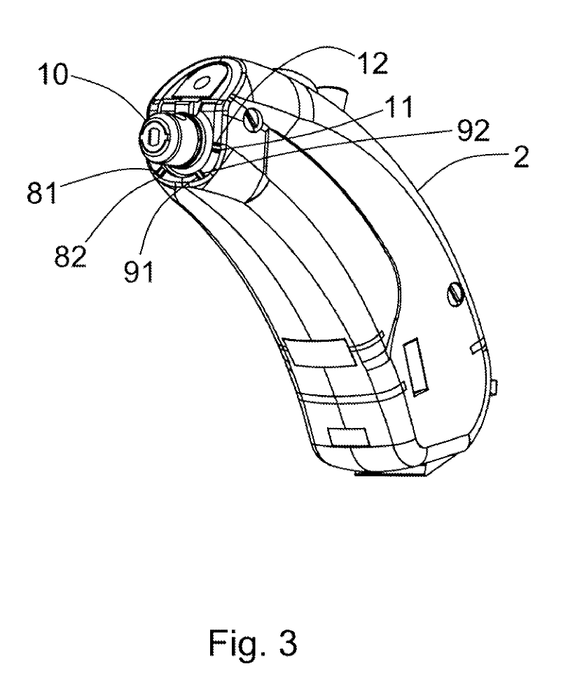

The hearing aid 1 according to the invention in FIG. 1 has a hearing aid housing 2 in which the electronics, including the output transducers, are located. Preferably, the electronics comprises digital circuitry, such as a digital signal processor and memory. At one end of the hearing aid housing 2 an interchangeable acoustic system 3 is attached. The interchangeable acoustic system 3 is shown separately in FIG. 2. The interchangeable acoustic system 3 in the embodiment shown comprises three parts: An earplug 4, a sound tube 5 and an adapter 6. The earplug 4 has openings 7, and is thus of the open type. The adapter shown is designed specifically for the hearing aid housing 2 and adapted for engaging a connector part 10 on said hearing aid housing 2. Such arrangements of connector parts 10 and adapters 6 are known per se and will not be dealt with in this application. It should however be noted that adapter and connector part is to be understood in the broadest possible sense, thus also including an adaptation of the inner or outer diameter of the sound tube to sockets or matching tubes on the hearing aid housing 2.

In order to allow the electronics of the hearing aid 1 in the hearing aid housing 2 to identify the interchangeable acoustic system 3 when the latter is attached to the hearing aid housing 2 thereof, the acoustic system 3 has an encoding in form of a number of angular spaced conductive areas 8, 9 of which only two are visible.

The hearing aid housing 2 of the hearing aid 1 has a number of pairs of contacts 81, 82; 91, 92; 11, 12, adapted to each of the conductive areas 8, 9, if present, so as to close an electric circuit. With e.g. four pairs of contacts on the hearing aid housing 2 of the hearing aid 1, the fourth pair of contacts, however, not being visible in the figures, it is thus possible to encode four bits of identification information into the interchangeable acoustic system 3, by appropriate choice of conductive areas 8, 9. In this respect a conductive area could represent “one” and a non-conductive area could represent “zero”. Thus if no conductive areas are present at all on the acoustic system 3, the four contact pairs 81, 82; 91, 92; 11, 12 of the hearing aid would detect 0000, and if conductive areas were present matching the locations of all four contact pairs 81, 82; 91, 92; 11, 12 the hearing aid would detect 1111. By appropriate selection of the locations of the conductive areas any binary number between 0000 and 1111 could thus be represented.

This would then allow the hearing aid 1 to identify sixteen different interchangeable acoustic systems 3 by means of the contact pairs 81, 82; 91, 92; 11, 12 on the housing. Since the possible lengths of the sound tubes 5 are typically reduced to a number such as three, this would be sufficient to identify for e.g. any combination open and closed earplug in three different lengths, and even different types of open earplugs 4 if necessary.

A memory forming part of the electronics of the hearing aid 1 and located within the hearing aid housing 2, stores a number of frequency characteristics corresponding to the number of possible interchangeable acoustic systems 3 to be used with hearing aid housing 2 in order to provide the overall hearing aid 1. In the above example only six are necessary, even though the encoding would allow up to sixteen. How to store such frequency characteristics is known per se and can e.g. be found in EP-A-341991 incorporated herein by reference. According to the encoding detected, the electronics of the hearing aid 1 selects an appropriate frequency characteristic modification for the signal to the output transducer so at to provide an appropriate signal for the users hearing deficiency, taking automatically into account the type of earplug used.

It should, however, be noted that one single bit encoding could be sufficient, because one user would normally only use one length of tube. Thus, a single conductive area could indicate a closed earplug, and no conductive area could indicate open earplug 4. Having only one conductive area is advantageous in the sense that it does not need the same precision in alignment, as when several areas must match several contact pairs. This is advantageous, when the angular rotation of the adapter with respect to the connecting part is not important during connection, e.g. if the adapter is simply the end of the sound tube 5. In that case, the conductive area would preferably be annular.

As an alternative to the use of several conductive areas as a means for encoding the different types of interchangeable acoustic systems, the resistance of the conductive area 8, 9 can be used. The hearing aid 1 then detects the resistance and uses this as an indication of the type of interchangeable acoustic system attached.

The number of frequency characteristics stored in the electronics within the housing 2 of the hearing aid 1 may be decided during design or during the fitting of the hearing aid 1 to a specific user. Typically the hearing aid will be designed to one specific type of acoustic system 3. For instance the electronics of the hearing aid 1 within the hearing aid housing 2 could be designed for use with an open earplug 4, a specific length and/or diameter of the sound tube 5, and a specific adapter 6. For this system no calibration data are established.

During the fitting, or possibly during design, different sets of calibration data are established. These calibration data control how the electronics of the hearing aid 1 is to compensate for the change in attached acoustic system 3. Thus a set of calibration data could be established for a closed earplug, indicating how to compensate for the lack of resonance in the ear canal, and other changes in acoustic properties.

Plenty of possibilities for achieving this compensation exist. The simplest example is a digital hearing aid 1 operating in several frequency bands, e.g. 15. In such a hearing aid 1 the compensation for the lack of resonance in the ear canal can be achieved by increasing the amplification in the frequency band around 3 kHz with an appropriate amount, e.g. 5 dB.

How different types of acoustic systems 3 interact with the user can be generally be modelled, but there may be individual differences falling outside of such models. It is thus preferable to store calibration data in the hearing aid 1 during the production thereof, but allowing adjustment of these during the fitting to the individual user.

Similarly, a compensation for other acoustic properties could be achieved. Take, e.g. a sound tube 5, which has a different damping than the one for which the hearing aid is designed. If this sound tube acts as a first-order high pass filter, this can be compensated by storing and using calibration data, which allows the hearing aid 1 to compensate with an amount which decreases with increasing frequency.

Though the above description has been given on the basis of embodiments with electrical contacts 8, 9; 81, 82; 91, 92; 11, 12 for identification of the interchangeable sound system 3, it should be noted that the invention is not limited to such. Rather, the skilled person will understand that plenty of ways of achieving such an identification exist. Such ways include optical sensors in the hearing aid housing, inductive means, RFID tagging, and other contactless identification means.

1. An acoustic system for a hearing aid, where said acoustic system is adapted for conducting sound from an output transducer in a housing of said hearing aid to an ear of a user, and where said acoustic system comprises an encoding indicating acoustical properties of the acoustic system.

2. The acoustic system according to claim 1, wherein said acoustic system comprises an earplug and wherein said encoding indicates whether the earplug is of the closed type or not.

3. The acoustic system according to claim 1, wherein said acoustic system comprises a length of sound tube, and wherein said encoding indicates the length of said sound tube.

4. The acoustic system according to claim 1, wherein said acoustic system comprises an adapter for attaching the acoustic system to said housing, and wherein said encoding comprises at least one electrically conductive area arranged in connection with the adapter.

5. The acoustic system according to claim 4, wherein said electrically conductive area arranged in connection with the adapter has a resistance value indicating the acoustical properties of the system.

6. The acoustic system according to claim 4, wherein said encoding comprises a plurality of electrically conductive areas arranged in connection with the adapter.

7. A hearing aid, comprising a hearing aid housing, where said housing has a connector part for attaching an acoustic system for conducting sound from an output transducer in said housing to an ear of a user, and where said hearing aid comprises detecting means for detecting an encoding of an attached acoustical system.

8. The hearing aid according to claim 7, wherein said detecting means comprises at least one pair of conductors arranged in connection with said connector part.

9. The hearing aid according to claim 7, wherein said detecting means comprises a plurality of pairs of conductors.

10. The hearing aid according to claim 7, wherein the sound produced by said output transducer is modified in accordance with the encoding detected.
